(19) United States
(12) Patent Application Publication
(10) Pub. No.: US 2024/0262632 A1
(43) Pub. Date: Aug. 8, 2024

(54) MODULAR CONVEYOR BELT WITH ROD RETAINERS

(71) Applicant: MASON PLASTICS CO., Winchester, TN (US)

(72) Inventor: William Mason, Winchester, TN (US)

(21) Appl. No.: 18/433,048

(22) Filed: Feb. 5, 2024

Related U.S. Application Data
(60) Provisional application No. 63/444,204, filed on Feb. 8, 2023.

(51) Int. Cl. B65G 17/40; B65G 17/08

(52) U.S. Cl. CPC B65G 17/40; B65G 17/083; B65G 2207/12

(57) ABSTRACT

A modular conveyor belt including a rod and a link configured for being connected to another link by the rod and comprising a plurality of laterally extending hinge members. Each hinge member has a hole therethrough configured for receiving the rod. The modular conveyor belt further includes a rod retainer rotatably connected to the link. The rod retainer comprises a stem having a first end and a second end opposite the first end, a hinge pin extending transversely from the first end of the stem and defining an axis of rotation of the rod retainer relative to the link, and a stopper extending from the second end of the stem and configured for engaging with and retaining the rod within the link. The stopper has a slot configured for receiving a tool for rotating the rod retainer about the axis of rotation.

### CROSS-REFERENCES TO RELATED APPLICATIONS

This application claims priority to U.S. Provisional Patent Application No. 63/444,204 entitled “MODULAR CONVEYOR BELT WITH ROD RETAINERS” filed on Feb. 8, 2023.

A portion of the disclosure of this patent document contains material that is subject to copyright protection. The copyright owner has no objection to the reproduction of the patent document or the patent disclosure, as it appears in the U.S. patent and Trademark Office patent file or records, but otherwise reserves all copyright rights whatsoever.

### STATEMENT REGARDING FEDERALLY SPONSORED RESEARCH OR DEVELOPMENT

Not Applicable

### REFERENCE TO SEQUENCE LISTING OR COMPUTER PROGRAM LISTING APPENDIX

Not Applicable

### BACKGROUND OF THE INVENTION

This disclosure relates generally to modular conveyor belts. More particularly, this disclosure pertains to assemblies and methods for constructing conveyor belts with rod retainers.

Modular conveyor belts generally include toothed modules or links that are movably coupled to one another by rods. The belts are typically supported by a conveyor frame and driven by a chain and accompanying drivetrain. Each link generally includes a main body and laterally extending connecting members which each have a rod hole therethrough. The connecting members of adjacent links interface with one another and the rod inserted through the holes thereof pivotally connect the adjacent links together.

Some modular conveyor belts include rod retainers disposed within the link. Therein, a link typically includes a pair of rod retainers respectively located at each longitudinal end of the link. The rod retainers are pivotally mounted on the link. The rod retainers serve as mechanical stops that act against the ends of the rod to retain the rod within the rod holes of adjacent links. Generally, conveyor belts require tight tolerances for avoiding excess wear and the buildup of debris. As a result, the rod retainers are typically snap-fitted and tightly held in place within the link. Accordingly, a rod retainer may be difficult to rotate and/or remove. Furthermore, as a consequence of the augmented difficulty, the user typically damages the link, the rod, and/or the rod retainer whilst attempting to rotate the rod retainer.

### BRIEF SUMMARY OF THE INVENTION

Aspects of the invention provide a modular conveyor belt. The modular conveyor belt includes links rotatably connected to one another by rods. The rods are held in place by rod retainers that are pivotally connected to the links. Each rod retainer includes a hinge pin and a stopper connected to one another by a stem. The hinge pin defines the axis of rotation of the rod retainer. The stopper engages with and prevents the rod from exiting the link. The stopper also serves as the point of contact for a tool to interface with the rod retainer. The point of contact(s) for rotating the rod retainer are located away from the axis of rotation at the hinge pin to increase leverage and accordingly decrease the force needed to rotate the rod retainer.

In one aspect, a modular conveyor belt includes a rod and a link configured for being connected to another link by the rod and comprising a plurality of laterally extending hinge members. Each hinge member has a hole therethrough configured for receiving the rod. The modular conveyor belt further includes a rod retainer rotatably connected to the link. The rod retainer comprises a stem having a first end and a second end opposite the first end, a hinge pin extending transversely from the first end of the stem and defining an axis of rotation of the rod retainer relative to the link, and a stopper extending from the second end of the stem and configured for engaging with and retaining the rod within the link. The stopper has a slot configured for receiving a tool for rotating the rod retainer about the axis of rotation.

In another aspect, a rod retainer of a modular conveyor belt is provided. The rod retainer is configured for rotatably connecting to a link. The rod retainer comprises a stem having a first end and a second end opposite the first end, a hinge pin extending transversely from the first end of the stem and defining an axis of rotation of the rod retainer, and a stopper extending from the second end of the stem. The stopper is configured for engaging with and retaining a rod connecting a pair of corresponding links. The stopper has a slot configured for receiving a tool for rotating the rod retainer about the axis of rotation.

In yet another aspect, there is provided a method. The method includes a step of providing a modular conveyor belt. The modular conveyor belt comprises a rod and a link configured for being connected to another link by the rod and comprising a plurality of laterally extending hinge members. Each hinge member has a hole therethrough configured for receiving the rod. The modular conveyor belt also includes a rod retainer rotatably connected to the link. The rod retainer comprises a stem having a first end and a second end opposite the first end, a hinge pin extending transversely from the first end of the stem and defining an axis of rotation of the rod retainer relative to the link, and a stopper extending from the second end of the stem and configured for engaging with and retaining the rod within the link. The stopper has a slot and an outer annular wall. The method also includes a step of engaging a tool with the slot for rotating the rod retainer about the axis of rotation. The method further includes a step of engaging the tool with the outer annular wall for rotating the rod retainer about the axis of rotation.

### BRIEF DESCRIPTION OF THE SEVERAL VIEWS OF THE DRAWINGS

FIG. 1 is a top perspective view of a prior art modular conveyor belt that includes links, rods, and rod retainers.

FIG. 2 is an end perspective view of the modular conveyor belt of FIG. 1, wherein the retainer is in its locked position for retaining the rod.

FIG. 3 is an end perspective view of the modular conveyor belt of FIG. 1, wherein the retainer is in its unlocked position which allows a user to remove the rod and disconnect the links.

FIG. 4 is a perspective view of a retainer of the modular conveyor belt of FIGS. 1-3.

FIG. 5 is a top perspective view of a modular conveyor belt according to an embodiment of the disclosure, the modular conveyor belt includes links, rods, and rod retainers.

FIG. 6 is an end perspective view of the modular conveyor belt of FIG. 5, wherein the retainers are in the locked position for retaining the respective rods.

FIG. 7 is an end perspective view of the modular conveyor belt of FIG. 5, wherein the retainers are in a first, partially unlocked position.

FIG. 8 is an end perspective view of the modular conveyor belt of FIG. 5, wherein the retainers are in a second, fully unlocked position.

FIG. 9 is a perspective view of a retainer of the modular conveyor belt of FIGS. 5-8.

FIG. 10 is a top view of the retainer of FIG. 9.

Reference will now be made in detail to optional embodiments of the invention, examples of which are illustrated in accompanying drawings. Whenever possible, the same reference numbers are used in the drawings and in the description referring to the same or like parts.

### DETAILED DESCRIPTION OF THE INVENTION

While the making and using of various embodiments are discussed in detail below, it should be appreciated that many applicable inventive concepts can be embodied in a wide variety of specific contexts. The specific embodiments discussed herein are merely illustrative of specific ways to make and use the invention and do not delimit the scope thereof.

To facilitate the understanding of the embodiments described herein, a number of terms are defined below. The terms defined herein have meanings as commonly understood by a person of ordinary skill in the areas relevant to the disclosure. Terms such as “a,” “an,” and “the” are not intended to refer to only a singular entity, but rather include the general class of which a specific example may be used for illustration. The terminology herein is used to describe specific embodiments of the invention, but their usage does not delimit the invention, except as set forth in the claims.

As described herein, an upright position is considered to be the position of apparatus components while in proper operation or in a natural resting position as described herein. Vertical, horizontal, above, below, side, top, bottom and other orientation terms are described with respect to this upright position during operation unless otherwise specified. The term “when” is used to specify orientation for relative positions of components, not as a temporal limitation of the claims or apparatus described and claimed herein unless otherwise specified. The terms “above”, “below”, “over”, and “under” mean “having an elevation or vertical height greater or lesser than” and are not intended to imply that one object or component is directly over or under another object or component.

The phrase “in one embodiment,” as used herein does not necessarily refer to the same embodiment, although it may Conditional language used herein, such as, among others, “can,” “might,” “may” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without operator input or prompting, whether these features, elements and/or states are included or are to be performed in any particular embodiment.

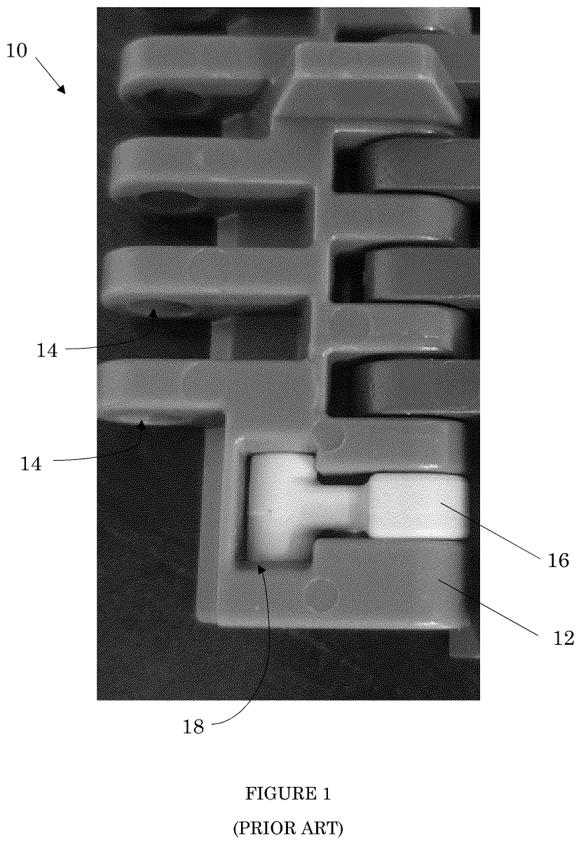

FIGS. 1-4 illustrate a prior art conveyor belt 10 that comprises links 12 interconnected to one another by rods (not shown). The rods are retained within corresponding rod holes 14 in the links 12 by rod retainers 16 at the lateral ends of the links 12. The conveyor belt 10 typically includes multiple links 12, rods, and rod retainers 16 for forming an endless belt.

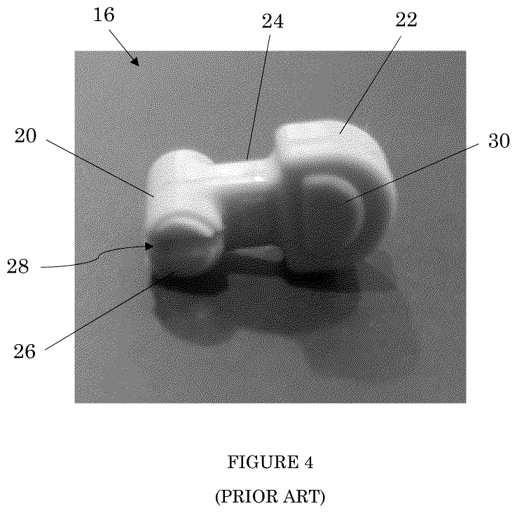

The rod retainers 16 are disposed within corresponding recesses 18 within the links 12 (FIG. 1). Each rod retainer 16 has a hinge pin 20 and a stopping head 22 interconnected by a middle stem 24 (FIG. 4). The hinge pin 20 defines a pivot axis about which the rod retainer 16 rotates. The hinge pin 20 has flanges 26 on its lateral ends which lock the rod retainer 16 in the recess 18 of the link 12. The hinge pin 20 also has slots 28 therein on each of its lateral sides. Each slot 28 extends into the flange 26 and into lateral end thereof. Each slot 28 also extends across the full width or diameter of the hinge pin 20. The stopping head 22 selectively blocks the outermost rod hole 14 to prevent or allow the rod to pass therethrough. The size and shape of the stopping head 22 matches the link 12. The stopping head 22 has a “D”-shaped cross-section that matches the outer profile of the link 12 which the stopping head 22 sits within. Thereby, the outer surface of the stopping head 22 is flush with the outer surface of the link 12. The stopping head 22 also includes a “D”-shaped protrusion 30 on each of its lateral ends (FIG. 4). The surface protrusions 30 contact the rods for locking the rods within the links 12. The annular portion of the surface protrusions 30 also engages with the inside wall of the holes 14 for biasing the rod retainer 16 to remain in its locked position.

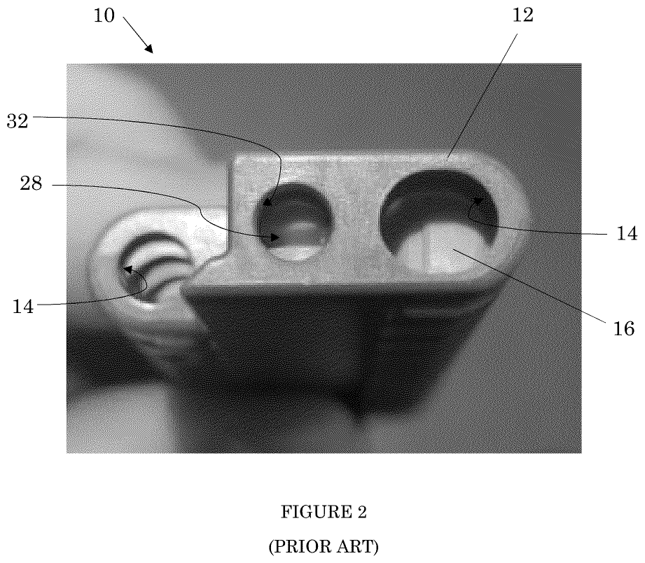

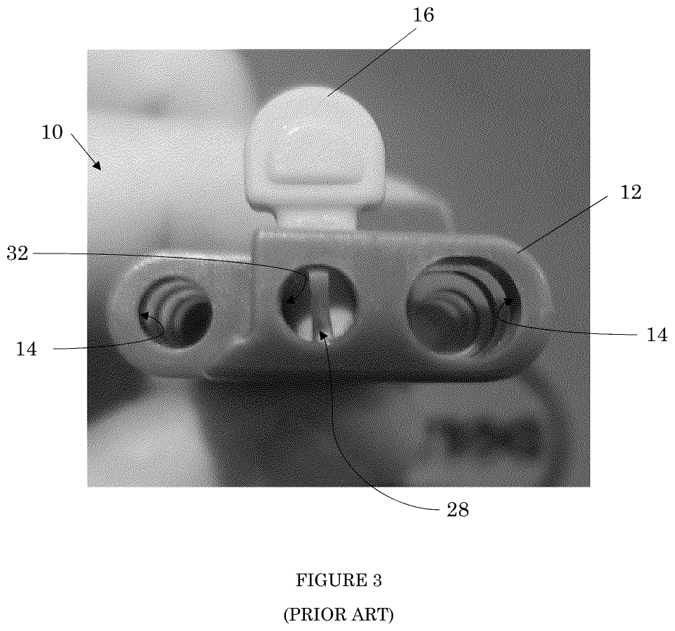

In operation, a user may insert a tool, such as a flat head screwdriver, through a hinge pin access hole 32 and into the slot 28 of the hinge pin 20 of the rod retainer 16 in order to rotate the rod retainer 16 in one continuous motion between its locked position (FIGS. 1-2) for retaining respective rods and its unlocked position (FIG. 3) for inserting and/or removing the respective rods. In the locked position, the rod retainer 16 is flush with the link 12 and the stopping head 22 blocks the outermost rod hole 14 to lock the rod within the link 12 (FIGS. 1-2). In the unlocked position, the rod retainer 16 extends beyond the bounds of the outer surface of the link 12 such that the longitudinal axis of the rod retainer 16 is substantially perpendicular to a longitudinal axis of the link 12 (FIG. 3). Additionally, in the unlocked position, the stopping head 22 is completely removed from the rod hole 14 which allows the rod to pass therethrough.

The prior art rod retainer 16 provides an effective locking mechanism once the stopping head 22 is rotated into the locked position. However, in use, rotating the rod retainer 16 is cumbersome and time consuming if not outright impossible to rotate without damaging the link 12, the rod, and/or the rod retainer 16 itself. The structural design of the rod retainer 16 itself, specifically the location of the slot 28 on the hinge pin 20, the shape and location of the flanges 26, and the shape and location of the surface protrusions 30 of the stopping head 22, makes it incredibly difficult to rotate the rod retainer 16. In other words, the rotational force applied through the tool (e.g., flat head screwdriver) by the user at the slot 28 of the hinge pin 20 cannot easily overcome the frictional and interference forces acting on the rod retainer 16. Typically, the user must use multiple tools and damage the link 12, the rod, and/or the rod retainer 16 in order to rotate the rod retainer 16 to the unlocked position. Once unlocked, the user must replace the damaged parts and reassemble the conveyor belt 10. Therefore, the prior art rod retainer 16 is ineffective, cumbersome to use, and causes increased part and labor costs.

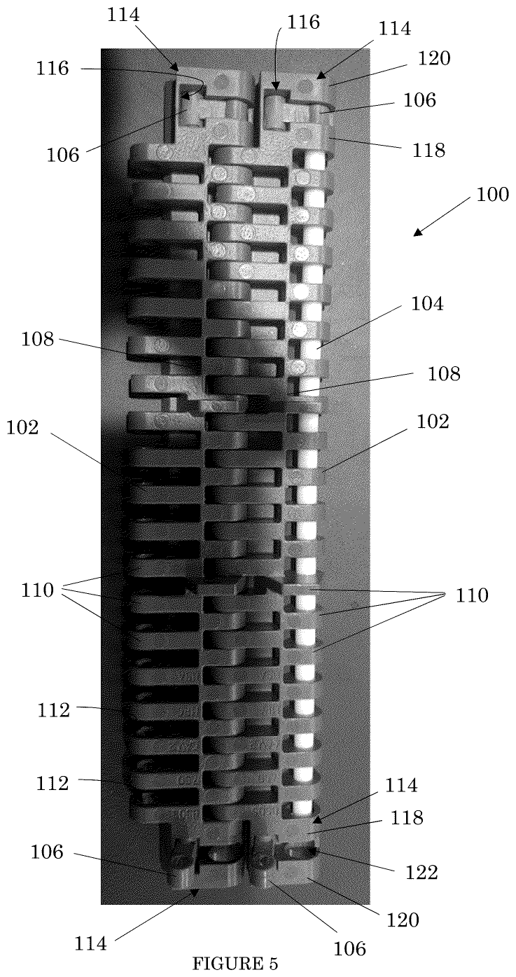

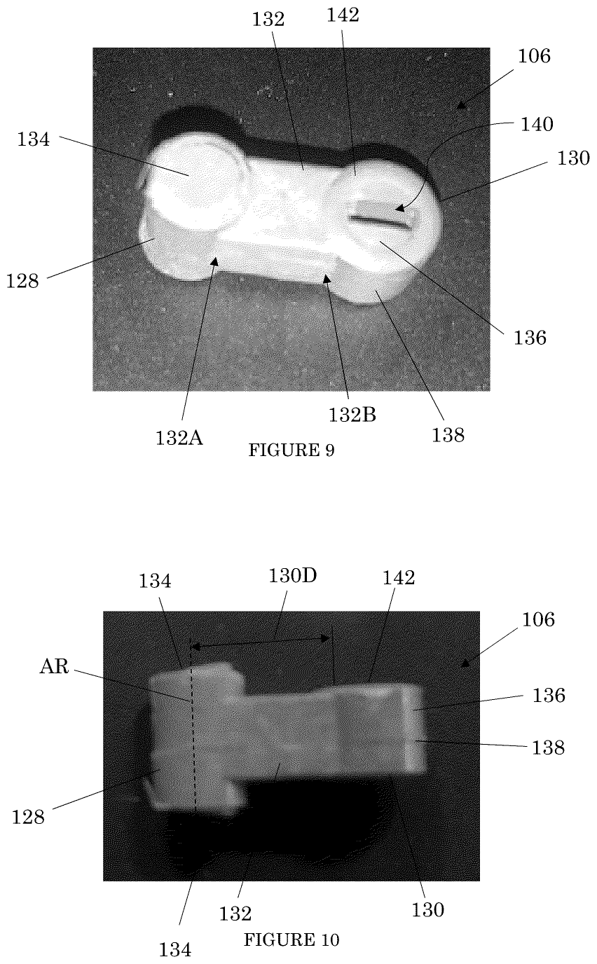

FIGS. 5-10 illustrate a modular conveyor belt 100 according to an exemplary embodiment of the disclosure. The modular conveyor belt 100 comprises links 102 interconnected to one another by elongated rods 104. Each rod 104 is held in place at each lateral end of the link 102 by a rod retainer 106 disposed within the link 102. Each rod retainer 106 is rotatable in between multiple positions, using a multi-stage process, to easily and efficiently lock the rod 104 within the link 102 or unlock the rod 104 so it may be removed from the link 102.

The modular conveyor belt 100 travels in a forward direction of conveyor travel. The modular conveyor belt 100 is configured for forming an endless belt which connects to itself and which may be modified, e.g., lengthened or shortened by adding or removing links 102, as desired. The modular conveyor belt 100 may include any desired number of links 102, rods 104, and rod retainers 106. The modular conveyor belt 100 may also include rollers for decreasing backline pressure. The modular conveyor belt 100 may be used in any desired industry. The modular conveyor belt 100 may be driven by any desired chain and drivetrain.

The rods 104 movably couple the links 102 to one another. The rods 104 may not extend the full length of the link 102. The rods 104 may or may not have a circular cross-section. One or both ends of the rod 104 may be chamfered or filleted for easily inserting the rod 104 through the links 102. Each rod 104 may comprise any desired material, such as plastic or metal. For example, each rod 104 may be injection-molded out of a thermoplastic polymer, such as polypropylene, polyethylene, or acetal.

The links 102 are movably connected to one another by the rods 104. Each link 102 includes a main body 108 that defines a longitudinal axis and multiple connecting hinge members 110 extending laterally from the main body 108. A single elongated link 102 or multiple shorter links may be placed end-to-end to form the overall width of the modular conveyor belt 100. It should be appreciated that the main body 108 may be distinct from the hinge members 110. Alternatively, portions of the hinge members 110 themselves may define the main body 108. Each link 102 may comprise any desired material, such as plastic. For example, each link 102 may be injection-molded out of a thermoplastic polymer, such as polypropylene, polyethylene, or acetal.

The connecting hinge members 110 may include link hinge members 110 and/or roller hinge members. The link hinge members 110 are configured for movably connecting adjacent links 102. Each link hinge member 110 has a body with a rod hole 112 therethrough that is configured for receiving the corresponding rod 104 (FIG. 5). The link hinge members 110 extend outwardly and substantially perpendicularly from the main body 108. The link hinge members 110 are located on both the leading and trailing sides of the main body 108. For example, both of the leading side and the trailing side of the main body 108 may have at least two link hinge members 110. The hinge members 110 may or may not be identical to one another. For instance, the leading link hinge members 110 may be longer than the trailing link hinge members 110.

Each link 102 further includes retainer mounts 114. The retainer mounts 114 are configured for mounting the rod retainers 106 and pivotally connecting the links 102. The retainer mounts 114 are located at the lateral ends of the link 102. In other words, the retainer mounts 114 define the lateral ends of the link 102. Each retainer mount 114 includes a body with a recess 116 therein for receiving the rod retainer 106 (FIG. 5). The recess 116 has a size and shape which corresponds to the size and shape of the rod retainer 106. For example, the recess 116 may have a rectangular cross section. Each recess 116 extends into the bottom, i.e., inward, drivetrain facing surface of the of the link 102.

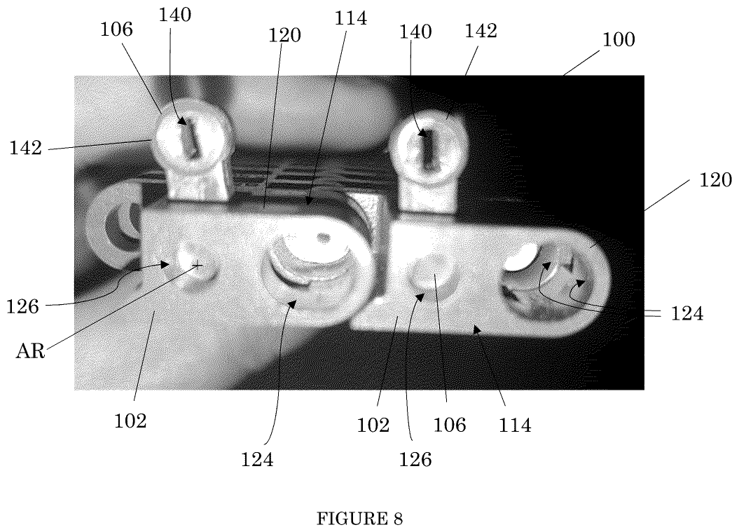

Each retainer mount 114 also includes a first, inner hinge member 118 and a second, outer hinge member 120 which both laterally extend away from the body of the retainer mount 114. In between the inner and outer hinge members 118, 120 of the retainer mount 114 is an opening or recess 122, as shown with respect to the bottom right retainer mount 114 in FIG. 5. The opening 122 of each retainer mount 114 opens into the recess 116 and opens toward the bottom surface, i.e., drivetrain facing surface, and side edge surface, i.e., link facing surface, of the retainer mount 114. The inner hinge member 118 may engage and interact with a corresponding link hinge member 110. The inner and outer hinge members 118, 120 may be substantially similar to the link hinge members 110 but for their thickness. The inner and outer hinge members 118, 120 may or may not be substantially identical to one another. The inner and outer hinge members 118, 120 may each have a rod hole 124 therethrough (FIG. 8). The rod hole(s) 124 of the inner and/or outer hinge member 118, 120 can be selectively blocked by the rod retainer 106.

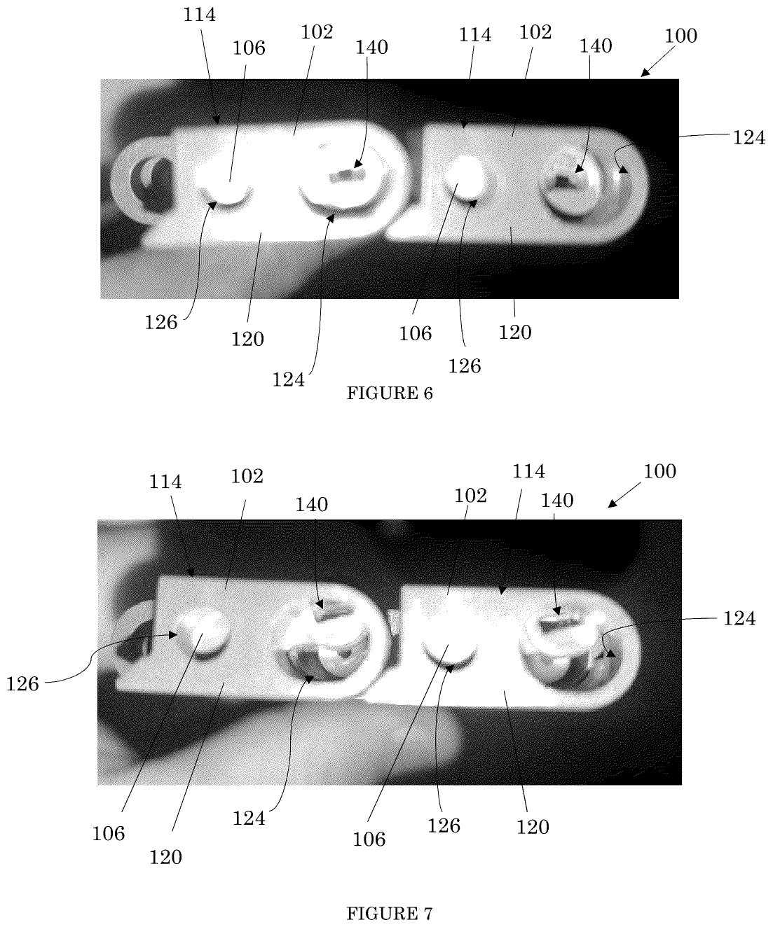

Each retainer mount 114 may also include hinge pin holes 126 or recesses. The hinge pin holes 126 may receive at least a portion of the rod retainer 106 and help define the axis of rotation AR of the rod retainer 106. For example, the inner and outer hinge members 118, 120 may each include a hinge pin hole 126 for receiving and retaining at least a portion of the rod retainer 106. The hinge pin holes 126 may or may not be through holes such that they are open at both lateral ends. Additionally, for example, only the outer hinge member 120 may include a hinge pin hole 126. Still further, for example, the retainer mount 114 may not include hinge pin holes 126. Therein, the rod retainer 106 may be pivotally mounted within the recess 116 alone without the use of additional holes. In the present exemplary embodiment, the retainer mount 114 has a first hinge pin hole 126 at one side of the recess 116 that does not extend through the body (not shown) and a second hinge pin hole 126 at the opposite side of the recess 116 that does extend through the body, which accordingly opens into the recess 116 and the outer lateral wall of the retainer mount 114 (FIGS. 6-8). The hinge pin hole(s) 126 may have a differing size and/or shape than the rod holes 124 of the retainer mount 114.

Each rod retainer 106 is rotatably connected to the link 102 via the retainer mount 114. The rod retainer 106 can be snap-fitted within the recess 116 of the retainer mount 114. Each rod retainer 106 comprises a hinge pin 128 and a stopper 130 connected by a middle stem 132. Each rod retainer 106 may comprise any desired material, such as plastic or metal. For example, each rod retainer 106 may be injection-molded out of a thermoplastic polymer, such as polypropylene, polyethylene, or acetal. Each rod retainer 106 may be a monolithic, single part component or a multipart component.

Each rod retainer 106 is configured for being rotatable in a multistage process, such as a two-stage or three-stage process. Each rod retainer 106 is rotatable in between a locked position (FIG. 6), an intermediary, partially unlocked position (FIG. 7), and a fully unlocked position (FIG. 8). In the locked position, the stopper 130 engages with and retains the rod 104 (FIG. 6). Thereby, a rod 104 is axially fixed in between the two corresponding rod retainers 106 at the lateral ends of the link 102. In the intermediary position, the stopper 130 at least partially engages with the rod 104 (FIG. 7). Therein, the stopper 130 may no longer be seated within or otherwise engaged with the inside wall of the rod hole 124 of the inner and/or outer hinge member 118, 120. In the fully unlocked position, the stopper 130 is unengaged with the rod 104 (FIG. 8). Meaning, the stopper 130 no longer contacts the rod 104 or otherwise blocks the rod holes 124. In the fully unlocked position, the rod retainer 106 may or may not be rotated to its fullest extent such that the stem 132 contacts the inner wall of the retainer recess 116 of the link 102.

The middle stem 132 of each rod retainer 106 extends along a longitudinal axis between a first end 132A and a second end 132B opposite the first end 132A. As shown, the middle stem 132 has a rectangular cross-section. However, the middle stem 132 may have any desired shape and size. The stem 132 may have a smaller width than the width or diameter of the hinge pin 128 and/or stopper 130.

The hinge pin 128 of each rod retainer 106 is connected to and extends transversely from the first end 132A of the stem 132. The hinge pin 128 is seated within the recess 116 of the retainer mount 114. The hinge pin 128 extends along a longitudinal axis between a first lateral end and a second lateral end. The longitudinal axis of the hinge pin 128 may be substantially transverse to the longitudinal axis of the stem 132. The hinge pin 128, and more particularly the longitudinal axis thereof, defines the axis of rotation AR of the rod retainer 106 relative to the link 102.

The hinge pin 128 includes flanges 134 on each of its lateral ends. Each flange 134 can be angled such that its width varies across its diameter. Each flange 134 has a smaller diameter than the diameter of the body of the hinge pin 128 at its lateral end. Each flange 134 may be centrally mounted on the lateral end of the hinge pin 128. Each flange 134 can have a circular cross section. The hinge pin 128 may engage with the hinge pin holes 126. For example, the hinge pin 128 at each lateral end, the front face thereof and/or the perimeter adjacent thereto, and/or the flanges 134 may engage with the inner surface(s) of the respective hinge pin hole 126. Additionally, for example, the outer perimeter of each flange 134 may engage with the inner surface of the respective hinge pin hole 126, and the face of the lateral end of the hinge pin 128, which surrounds the flange 134, may engage with the juxtaposed face of the recess 116 which surrounds the hinge pin hole 126.

The stopper 130 of each rod retainer 106 is connected to and extends transversely from the second end 132B of the stem 132. The stopper 130 is configured for engaging with and retaining the rod 104 within the link 102. In other words, the stopper 130 is configured for selectively blocking the rod hole(s) 124 of the inner and/or outer hinge members 118, 120 of the retainer mount 114 of each link 102 for preventing the rod 104 to pass therethrough. The profile of the stopper 130 may not match the profile the hinge members 118, 120. The diameter of the stopper 130 can be smaller than the diameter of the end of the hinge members 118, 120. Therein, the outer surface of the stopper 130 may not be flush with the outer surface of the hinge members 118, 120. The reduction in size of the stopper 130 creates less surface area in contact with the link 102; and thus, the stopper 130 reduces friction between the rod retainer 106 and the link 102.

The stopper 130 includes an annular body 136, with an outer annular wall 138, that extends along a longitudinal axis in between a first lateral end and a second lateral end. The longitudinal axis of the stopper 130 may be substantially transverse to the longitudinal axis of the stem 132. The stopper 130 may be parallel to the hinge pin 128. The annular body 136 has a first, rod side face on the first lateral end which is configured for engaging with the rod 104 and a second, tool side face opposite the first face on the second lateral end which is configured for engaging with the tool. The outer annular wall 138 extends between the first and second faces. The ends of the outer annular wall 138 join with the top and bottom walls of the stem 132. The outer annular wall 138 is also configured for engaging with the tool.

The stopper 130 has a slot 140 configured for receiving the tool for rotating the rod retainer 106 about its axis of rotation AR. The slot 140 may be located on the second lateral end of the annular body 136, opening toward the second face. The slot 140 may or may not be a through hole such that it is open on one or both ends. The slot 140 may have at least one opening which opens toward the second, tool side face. The at least one opening of the slot 140 can be flush with the second, tool side face. As shown, the slot 140 extends through the annular body 136 of the stopper 130 and it is open at both of its ends. The slot 140 may be parallel to the longitudinal axis of the annular body 136.

The stopper 130 also has at least one annular protrusion 142 on at least one of its lateral ends. The at least one annular protrusion 142 encircles the slot 140. The at least one annular protrusion 142 is configured for dually engaging with the rod and mechanically locking the rod retainer 106. In more detail, the outer rim of the annular protrusion 142 engages with the inside wall of the respective rod hole 124 of the retainer mount 114. The diameter of the outer rim of the at least one protrusion 142 may match or be smaller than the diameter of the annular body 136 of the stopper 130. The stopper 130 may include an annular protrusion 142 on each of its lateral ends. The stopper 130 may include only one annular protrusion 142 that is located on its tool side face. A single annular protrusion 142 may reduce the frictional forces acting on the rod retainer 106.

In operation, the following method may be performed to rotate the rod retainer 106. As discussed above, the process of rotating the rod retainer 106 is a multistage process. In the first stage, a user may insert a tool, such as a flathead screwdriver, through the rod hole 124 of the outer hinge member 120 of the retainer mount 114 so that the tool engages with the slot 140 of the stopper 130 for rotating the rod retainer 106. The user may apply a crosswise force which easily overcomes the frictional forces acting on the rod retainer 106 and which accordingly rotates the rod retainer 106 into its intermediary, partially unlocked position (FIG. 7). Once the annular protrusion(s) 142 is (are) located outside of, i.e., disengaged with, the rod hole(s) 124 of the retainer mount 114, the rod retainer 106 becomes much easier to rotate. In the second stage, the tool engages with an outer surface of the stopper 130 for rotating the rod retainer 106. Hence, the user may engage the tool with the outer annular wall 138 of the annular body 136, or other outer portion of the stopper 130, to further rotate the rod retainer 106 so that the stopper 130 no longer resides within the opening 122. In other words, the stopper 130 no longer blocks any portion of the rod holes 124. Thereafter, the user may further engage the tool with slot 140, another portion of the stopper 130, e.g., the outer annular wall 138, and/or the stem 132, to rotate the rod retainer 106 into its fully unlocked position.

Each rod retainer 106 comprises at least two tool contact points spaced apart from the axis of rotation AR and configured for engaging with the tool for rotating the rod retainer 106. The first contact point may be defined by the slot 140, which allows a tool to fit therein. The second contact point may be defined by the outer annular wall 138. The rod retainer 106 may include an additional contact point, such as the inner rim of the annular protrusion 142 on the tool side face of the stopper 130. Each contact point, such as the slot 140 and the outer annular wall 138 of the stopper 130, are located at a distance 130D away from the axis of the rotation AR or in other words the center point of the hinge pin 128 (FIG. 10). The contact points of the stopper 130 of the rod retainer 106 provide for a greater amount of leverage as compared to the prior art rod retainer 16. In more detail, the distance 130D between the contact points and the axis of rotation AR reduces the requisite force needed to rotate the rod retainer 106. This distance 130D is at least the length of the stem 132 and half of the diameter of the hinge pin 128. In other words, the distance 130D spans from the axis of rotation AR to the start of the outer annular wall 138 where it connects to the stem 132. Additionally, the rod retainer 106 has fewer points of friction which leads to less frictional forces acting on the rod retainer 106, as compared to the prior art rod retainer 16. Thereby, the rod retainer 106 is easier to rotate and more efficient to use than the prior art rod retainer 16.

It is contemplated within the scope of the claims that the rods, the links, the hinge members, the rollers if equipped, and/or the rod retainers of a conveyor belt may or may not be identical components. It is contemplated within the scope of the claims that although a plurality of rods, links, hinge members, rollers, and rod retainers may be substantially identical, a conveyor belt assembly may contain rods, links, hinge members, rollers, and rod retainers that differ in shape and size from those in the plurality without departing from the scope of the claims.

This written description uses examples to disclose the invention and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

It will be understood that the particular embodiments described herein are shown by way of illustration and not as limitations of the invention. The principal features of this invention may be employed in various embodiments without departing from the scope of the invention. Those of ordinary skill in the art will recognize numerous equivalents to the specific procedures described herein. Such equivalents are considered to be within the scope of this invention and are covered by the claims.

All of the compositions and/or methods disclosed and claimed herein may be made and/or executed without undue experimentation in light of the present disclosure. While the compositions and methods of this invention have been described in terms of the embodiments included herein, it will be apparent to those of ordinary skill in the art that variations may be applied to the compositions and/or methods and in the steps or in the sequence of steps of the method described herein without departing from the concept, spirit, and scope of the invention. All such similar substitutes and modifications apparent to those skilled in the art are deemed to be within the spirit, scope, and concept of the invention as defined by the appended claims.

Thus, although there have been described particular embodiments of the MODULAR CONVEYOR BELT WITH ROD RETAINERS it is not intended that such references be construed as limitations upon the scope thereof except as set forth in the following claims.

What is claimed is:

1. A modular conveyor belt, comprising:
a rod;
a link configured to connect to another link via the rod, said link comprising a plurality of laterally extending hinge members, each hinge member having a hole therethrough configured to receive the rod therethrough when the belt is assembled; and
a rod retainer comprising:
a stem having a first end and a second end opposite the first end;
a hinge pin extending at the first end of the stem, said hinge pin extending along and defining an axis of rotation of the rod retainer; and
a stopper at the second end of the stem, said stopper configured to engage the link and retain the rod within the link when the belt is assembled, the stopper having a recess configured to receive a tool for rotating the rod retainer about the axis of rotation.

2. The modular conveyor belt of claim 1, wherein:
the recess of the stopper is a slot;
the rod retainer is configured to rotate about the axis of rotation when the belt is assembled in a two-stage process, said process having a first stage and a second stage, wherein:
in the first stage, the tool engages the slot for rotating the rod retainer; and
in the second stage, the tool engages with an outer surface of the stopper for rotating the rod retainer.

3. The modular conveyor belt of claim 1, wherein:
the rod retainer is rotatable about the axis of rotation between:
a locked position wherein the stopper engages with and retains the rod in the holes through the hinge members of the link when the belt is assembled;
a partially unlocked position wherein the stopper at least partially engages with the rod to retain the rod in the holes through the hinge members of the link when the rod is in the holes through the hinge members; and
a fully unlocked position wherein the stopper is does not engage the rod to retain the rod in the holes through the hinge member so the link when the rod is in the holes through the hinge members.

4. The modular conveyor belt of claim 1, wherein:
the recess of the stopper is a slot;
the stopper of the rod retainer comprises an outer annular wall; and
the rod retainer comprises two contact points each spaced apart from the axis of rotation and configured for engaging with the tool for rotating the rod retainer, the two contact points comprising:
a first contact point defined by the slot of the stopper; and
a second contact point defined by the outer annular wall of the stopper.

5. The modular conveyor belt of claim 1, wherein:
the recess of the stopper is a slot;
the stopper of the rod retainer has at least one annular protrusion which encircles the slot; and
the at least one annular protrusion is configured for engaging with the rod and mechanically locking the rod retainer with the at least one annular protrusion extending longitudinally within the hole through the link member to retain the rod retainer in the locked position when the belt is assembled and the rod retainer is in the locked position.

6. The modular conveyor belt of claim 1, wherein:
the stopper of the rod retainer comprises an annular body; and
the annular body has a first face configured for engaging with the rod, a second face opposite the first face and configured for engaging with the tool, and an outer annular wall extending from the first face to the second face and configured for engaging with the tool.

7. The modular conveyor belt of claim 1, wherein:
the recess of the stopper is a slot;
the stopper of the rod retainer comprises an annular body; and
the slot extends through the annular body.

8. The modular conveyor belt of claim 1, wherein:
the recess of the stopper is a slot;
the stopper of the rod retainer has a tool side face;
the slot of the stopper has at least one opening which opens toward the tool side face; and
the at least one opening of the slot is flush with the tool side face.

9. The modular conveyor belt of claim 1, wherein:
the link further comprises a retainer mount having a recess that is configured for receiving the rod retainer therein and a hole that is coaxial with the hole of each hinge member of the plurality of hinge members; and
the stopper is configured for selectively blocking the hole of the retainer mount for preventing the rod to pass therethrough.

10. The modular conveyor belt of claim 1, wherein:
the endless belt comprises a plurality of rods, a plurality of links, and a plurality of rod retainers; and
each link of the plurality of links is connected to an adjacent link of the plurality of links by a rod of the plurality of rods such that the plurality of links, plurality of rods, and plurality of rod retainers forms an endless belt or loop.

11. A rod retainer for a modular conveyor belt, the rod retainer configured for rotatably connecting to a link, the rod retainer comprising:
a stem having a first end and a second end opposite the first end;
a hinge pin extending at the first end of the stem, said hinge pin extending along and defining an axis of rotation of the rod retainer; and
a stopper at the second end of the stem, said stopper configured to engage the link and retain the rod within the link when the belt is assembled, the stopper having a recess configured to receive a tool for rotating the rod retainer about the axis of rotation.

12. The rod retainer of claim 11, wherein:
the recess of the stopper is a slot;
the rod retainer is configured for being rotatable in a two-stage process having a first stage and a second stage;
in the first stage the tool engages with the slot for rotating the rod retainer; and
in the second stage the tool engages with an outer surface of the stopper for rotating the rod retainer.

13. The rod retainer of claim 11, wherein:
the rod retainer is rotatable in between:
a locked position wherein the stopper engages with and retains the rod;
a partially unlocked position wherein the stopper at least partially engages with the rod; and
a fully unlocked position wherein the stopper is unengaged with the rod.

14. The rod retainer of claim 11, wherein:
the recess of the stopper is a slot;
the stopper of the rod retainer comprises an outer annular wall; and
the rod retainer comprises two contact points each spaced apart from the axis of rotation and configured for engaging with the tool for rotating the rod retainer, the two contact points comprising:
a first contact point defined by the slot of the stopper; and
a second contact point defined by the outer annular wall of the stopper.

15. The rod retainer of claim 11, wherein:
the recess of the stopper is a slot;
the stopper of the rod retainer has at least one annular protrusion which encircles the slot; and
the at least one annular protrusion is configured for engaging with the rod and mechanically locking the rod retainer.

16. The rod retainer of claim 11, wherein:
the stopper of the rod retainer comprises an annular body; and
the annular body has a first face configured for engaging with the rod, a second face opposite the first face and configured for engaging with the tool, and an outer annular wall extending from the first face to the second face and configured for engaging with the tool.

17. The rod retainer of claim 11, wherein:
the recess of the stopper is a slot;
the stopper of the rod retainer comprises an annular body; and
the slot extends through the annular body.

18. The rod retainer of claim 11, wherein:
the recess of the stopper is a slot;
the stopper of the rod retainer has a tool side face;
the slot of the stopper has at least one opening which opens toward the tool side face; and
the at least one opening of the slot is flush with the tool side face.

19. The rod retainer of claim 11, wherein:
the stopper is configured for selectively blocking a hole of a retainer receiving member of the link for preventing the rod to pass therethrough.

20. A method, comprising:
providing a modular conveyor belt, the modular conveyor belt comprising a rod, a link configured for being connected to another link by the rod and comprising a plurality of laterally extending hinge members, each hinge member having a hole therethrough configured for receiving the rod, and a rod retainer rotatably connected to the link, the rod retainer comprising a stem having a first end and a second end opposite the first end, a hinge pin extending transversely from the first end of the stem and defining an axis of rotation of the rod retainer relative to the link, and a stopper extending from the second end of the stem and configured for engaging with and retaining the rod within the link, the stopper having a slot and an outer annular wall;
engaging a tool with the slot for rotating the rod retainer about the axis of rotation; and
engaging the tool with the outer annular wall for rotating the rod retainer about the axis of rotation.
